(19) United States
(12) Patent Application Publication
(10) Pub. No.: US 2002/0150659 A1
(43) Pub. Date: Oct. 17, 2002

(54) pH enhanced meat composition and method for producing a pH enhanced meat composition

(76) Inventor: Eldon Roth, Dakota Dunes, SD (US)

Correspondence Address: Russell D. Culbertson, Shaffer & Culbertson, L.L.P., Building One, Suite 360, 1250 Capital of Texas Highway, S., Austin, TX, 78746, US

(21) Appl. No.: 09/833,866

(22) Filed: Apr. 12, 2001

(51) Int. Cl. A23C 1/00

(52) U.S. Cl. 426/319

(57) ABSTRACT

A pH enhanced meat composition is produced by increasing the moisture content of an initial comminuted meat composition and producing an ammonium hydroxide solution in the comminuted meat composition. Mechanical action is preferably applied to the moisture enhanced meat composition after or concurrently with producing the ammonium hydroxide solution in the composition. The resulting pH enhanced meat product may then be formed into a desired shape and set in that shape by cooking or some other setting technique.

### CROSS-REFERENCE TO RELATED APPLICATION

This application is related to U.S. patent application Ser. No. 09/286,699, filed Apr. 6, 1999, entitled “APPARATUS FOR TREATING AMMONIATED MEATS” (as amended), now U.S. Pat. No. 6,142,067, and to U.S. patent application Ser. No. 09/579,783, filed May 26, 2000, entitled “METHOD FOR TREATING AMMONIATED MEATS” now U.S. Pat. No. ______. The entire content of each of these applications is incorporated herein by this reference.

### TECHNICAL FIELD OF THE INVENTION

The invention relates to meat products and meat processing. More particularly, the present invention relates to a pH enhanced comminuted meat composition and a method for producing a pH enhanced comminuted meat composition.

### BACKGROUND OF THE INVENTION

It has been found that modifying the pH of a meat product with ammonia may significantly reduce the live microbe content in the meat. This is particularly the case when the pH enhanced meat product is physically manipulated in a frozen state. Ammoniated meat products may also have other desirable characteristics unrelated to reduced microbe count.

It is also known to apply aqueous ammonia (ammonium hydroxide solution in water) or gaseous ammonia to large cuts of meat. The 1976 publication to Smol'skii et al. entitled “Method for Storage of Meat” discloses applying gaseous or aqueous ammonia to large cuts of meat to greatly increase the pH at a surface of the meat. That publication indicates that treating the large cuts of meat in this fashion helps preserve the meat in cold storage. U.S. Pat. No. 3,023,109 to Hines shows applying gaseous ammonia to cuts of red meat to produce a bright red color in the meat.

In order to produce the desired effects in an ammoniated meat product made up of comminuted meat, it is necessary to ensure a consistent pH adjustment or enhancement throughout the mass of comminuted meat. The problem of ensuring a consistent pH adjustment in comminuted meats is addressed in related U.S. patent application Ser. No. 09/286,699, now U.S. Pat. No. 6,142,067, and application Ser. No. 09/579,783, now U.S. Pat. No. ______. These documents disclose the process of first comminuting meat, exposing the comminuted meat to gaseous or aqueous ammonia, and then further comminuting the resulting ammoniated meat with a suitable comminuting device such as a grinder or bowl chopper. This process has been shown to help ensure a consistent pH adjustment throughout the comminuted meat product and to help eliminate any residual ammonia odor in the resulting product.

These prior related applications by the present inventor did not address the application of ammonia in situations where it is either unnecessary or undesirable to further comminute the meat after the application of ammonia. This is the case with meat batters for producing sausage or hotdogs, and is also the case in certain processes for producing restructured meat products. In the case of meat batters for producing sausage or hotdogs, it is unnecessary to further comminute the batter. Restructured meat products such as restructured beef and ham, for example, may be produced by taking relatively large chunks of meat and mixing the large chunks with a finely comminuted meat paste. The meat paste in the mixture is used as a binder to help bind the larger chunks of meat together to produce the final restructured product. In the case of these types of restructured meat products, it is undesirable to further comminute the chunk/paste mixture since comminuting the mixture reduces the size of the relatively large chunks.

### SUMMARY OF THE INVENTION

It is an object of the present invention to provide a method for producing a comminuted, pH enhanced meat composition which does not require that the meat be comminuted further after the pH modifying material is added. Another object of the invention is to provide a pH enhanced meat composition produced according to the present method.

The present method includes increasing the moisture content of a comminuted meat composition to produce a moisture enhanced meat composition. The method also includes producing an ammonium hydroxide solution in the meat composition. Mechanical action is preferably applied to the meat composition after or concurrently with producing the ammonium hydroxide solution in the composition. The resulting pH enhanced meat composition may be used as a meat batter which may be combined with other material or used alone for producing hotdogs, sausages, or restructured meat products.

Moisture content in the comminuted meat may be increased by simply adding liquid water or ice to an initial comminuted meat composition or to a meat composition that has been exposed to ammonia. Where liquid water is added, the water may be potable water alone or a solution of ammonium hydroxide in water, that is, aqueous ammonia. In the latter case the step of adding the water/ammonium hydroxide solution not only increases the moisture content of the initial meat composition but also concurrently produces the desired ammonium hydroxide solution in the meat composition. When the moisture content in the initial meat composition is increased by adding water with no ammonium hydroxide content, the ammonium hydroxide solution may be created by contacting the moisture enhanced meat composition with ammonia gas. Contact with the ammonia gas allows the ammonia to go into solution in the water associated with the moisture enhanced meat composition. Alternatively, the ammonium hydroxide solution in the meat composition may be created as water is added to comminuted meat which has already been exposed to ammonia.

“Mechanical action” as used in this disclosure and the accompanying claims means producing relative movement within the mass of moisture enhanced meat. This mechanical action may be applied in any number of ways within the scope of the invention. For example, the moisture enhanced meat composition may be put in a suitable mechanical mixer or blender having paddles or other mechanical elements which are driven through the mass of moisture enhanced meat composition. Alternatively, a gas may be directed through a mass of moisture enhanced meat composition. The injected gas produces bubbles which displace the meat as the bubbles work their way through the meat composition. This displacement caused by the gas bubbles produces mechanical action within the scope of the invention. Displacing the meat composition through a conduit may also produce the desired mechanical action in the meat composition depending upon the flow rate, nature of the meat composition, and the diameter of the conduit.

These and other objects, advantages, and features of the invention will be apparent from the following description of the preferred embodiments, considered along with the accompanying drawings.

### BRIEF DESCRIPTION OF THE DRAWINGS

FIG. 1 is a flow chart showing the method steps according to the present invention.

FIG. 2 is a diagrammatic representation of an apparatus for performing the method shown in FIG. 1.

FIG. 3 is a diagrammatic representation of an alternate apparatus for performing the method shown in FIG. 1.

### DESCRIPTION OF THE PREFERRED EMBODIMENTS

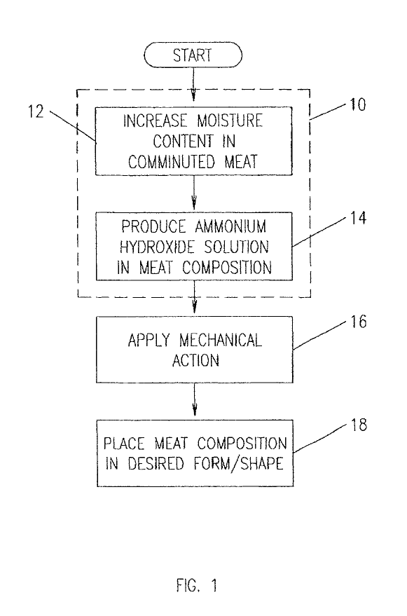

Referring to FIG. 1, the invention includes two basic steps shown in dashed box 10. One basic step comprises increasing the moisture content in a comminuted meat to produce a moisture enhanced meat composition as shown at process block 12. The other basic step comprises producing an ammonium hydroxide solution in the meat composition as shown at process block 14 in FIG. 1. Another basic step which may be helpful, but not necessary, is to apply mechanical action to the moisture enhanced meat composition after producing the ammonium hydroxide solution in the meat composition. In some cases, mechanical action may also be applied concurrently with producing the ammonium hydroxide solution in the meat composition. The application of mechanical action is shown at process block 16 in FIG. 1.

The process starts with an initial comminuted meat and may be performed as a continuous or batch process. The initial comminuted meat may be beef, pork, lamb, mutton, poultry, fish, or a combination of any of these types of meat. In addition to actual meat protein or muscle, the initial comminuted meat will commonly include some level of fat content depending upon the desired final product. Spices, seasonings, fillers, or other materials may also be included in the initial comminuted meat. Alternatively, these other materials may be added after the steps shown at process blocks 12 and 14 in FIG. 1. The invention is particularly useful in connection with meat batters which may be used to produce hotdogs, sausage, or restructured meat products. The meat batter may comprise the initial comminuted meat, or a meat batter may be produced from the pH enhanced meat composition resulting from the steps shown at blocks 12 and 14 in FIG. 1. The nature of the meat batter will depend upon the nature of the product to be produced. For example, finely textured hot dog and sausage batter will generally be made up of finely comminuted meats. Batter for producing restructured meat may include relatively large chunks of meat together with finely comminuted meat or meat paste. The relatively large chunks of meat may have a minimum dimension of more than one half (0.5) inch.

The present invention may be applied to substantially any initial meat composition which is at least partially made up of “small” pieces of comminuted meat. As used in this disclosure and the accompanying claims the term “small” when referring to comminuted meat pieces shall mean pieces small enough in size so that the pH of the entire piece of material may be changed by the ammonium hydroxide solution in the moisture enhanced meat composition. For uncooked meat, at least one dimension of such a piece of meat will be not more than approximately one-half (0.5) inch. Thus, as set out in this disclosure and the accompanying claims, a “small” piece of comminuted meat comprises any piece of meat having at least one dimension of not more than approximately one-half (0.5) inch. Preferably, the entire initial meat composition is made up of small pieces of comminuted meat. If a restructured meat batter calls for larger pieces of meat in the meat batter, those larger pieces are preferably added after the present process is applied to a composition of small comminuted meat pieces. Also, the term “large” when referring to comminuted meat pieces will mean pieces having a minimum dimension over one-half (0.5) inch.

The two basic steps shown at process blocks 12 and 14 may be accomplished in a number of different ways within the scope of the present invention. One preferred process includes two discrete steps. In one form of the invention the first step includes adding water (in liquid form and/or as ice) to the initial comminuted meat, and then producing the ammonium hydroxide solution in the moisture enhanced meat composition as a separate step after adding water. In this two-step process, the step of producing the ammonium hydroxide solution in the moisture enhanced meat composition may be performed by placing ammonia gas in contact with the meat composition. Particularly where mechanical action is applied to the moisture enhanced meat composition as shown at process block 16 in FIG. 1, the ammonia gas need not be at an elevated pressure in order to produce the desired ammonium hydroxide solution in the meat composition. Rather, ammonia from the gas readily goes into solution in the water associated with the moisture enhanced meat composition to produce the ammonium hydroxide solution.

In an alternate form of the invention, an initial comminuted meat product may be exposed to ammonia first and then water may be added to the ammoniated meat. In this case, the ammonium hydroxide solution is produced as the previously applied ammonia goes into solution in the added water. Particularly in this form of the invention care should be taken to ensure that the initially applied ammonia does not locally denature the comminuted meat. A gradual addition of ammonia to the meat composition is preferred to avoid locally denaturing the meat. It may be necessary to apply ammonia and then water in a number of cycles to effect the desired overall pH adjustment without denaturing portions of the meat.

Alternatively to two discrete steps, moisture may be added to the initial comminuted meat composition at the same time the desired ammonium hydroxide solution is produced in the meat composition. In this alternative implementation, an ammonium hydroxide solution is added to the initial meat composition. The water in the solution increases the moisture content in the initial comminuted meat to produce the moisture enhanced meat composition. Also, it is possible to combine the two-step approach and single step approach. That is, water may be added to an initial comminuted meat in a separate step and then the desired ammonium hydroxide solution may be produced in the meat composition by adding an ammonium hydroxide solution. Of course, adding ammonium hydroxide solution not only produces a desired solution in the meat composition but also further enhances the moisture content in the composition. Also, ammonium hydroxide solution may be added to the initial meat composition and the concentration of ammonium hydroxide solution may be increased later by contacting the composition with ammonia gas.

In any of these alternatives, the resulting comminuted meat composition has an enhanced pH. This enhanced pH has been found beneficial in meat products. The water added according to the invention serves to distribute the ammonia throughout the product and help eliminate any undesirable ammonia odor in the resulting uncooked composition and any residual ammonia odor or taste in the cooked product.

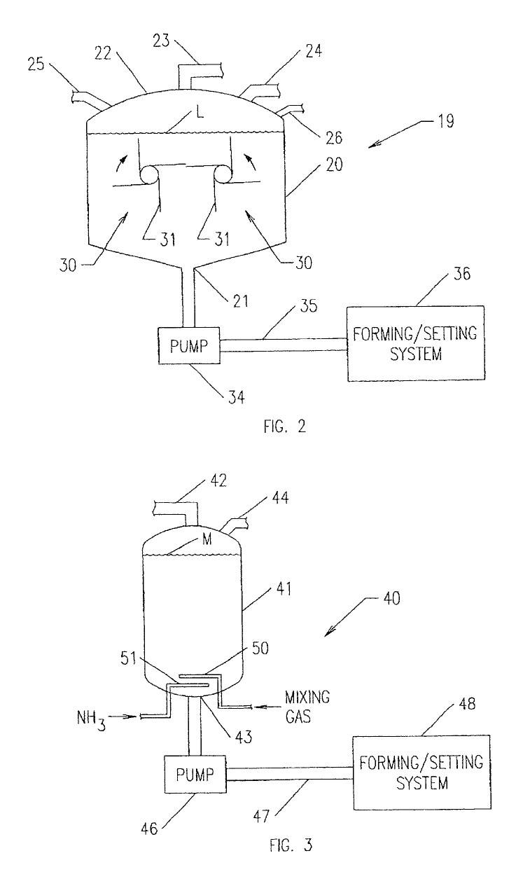

The application of mechanical action shown at process block 16 in FIG. 1 is helpful in certain circumstances to distribute the water and desired ammonium hydroxide solution throughout the moisture enhanced meat composition. Mechanical action may also be helpful in producing the desired meat batter by helping extract myosin-type proteins out of the meat pieces as is known in the art. The mechanical action according to the invention may be applied with a paddle or other element driven through a mass of the meat composition. An example of a paddle-type apparatus for applying mechanical action is shown in FIG. 2. Alternatively, a gas may be injected into the mixture to force the desired movement in the material. This gas injection-type of mechanical action will be discussed below with reference to the apparatus shown in FIG. 3.

The process according to the invention may be performed under a wide range of parameters. For example, the temperature of the meat composition should be a temperature high enough to ensure that at least some liquid water exists in the meat composition. Also, the temperature of the meat composition at the time the ammonium hydroxide solution is produced in the material should be high enough to allow the meat composition to be workable or flowable. Meat composition temperatures generally above 28 degrees Fahrenheit will be sufficient for most circumstances. The maximum temperature of the meat composition for the purposes of the present invention will be limited generally by the temperature at which the meat in the composition begins to cook or set. That is, the temperature of the meat composition should be low enough that the meat in the composition does not cook or is not cooked in the course of the present process.

Due in part to the solubility of ammonia in water, only a minimal moisture increase to the initial comminuted meat composition is necessary according to the invention. Generally, the increase in moisture content shown as process block 12 in FIG. 1 may be any increase that raises the moisture content above that naturally occurring in the initial meat composition. For example, ground beef containing 30% fat will have a moisture (water) content of approximately 65% by weight in the overall material. A moisture increase within the scope of the invention for such a meat composition may comprise an increase which raises the moisture content over 65%. Where the initial meat composition has less fat content, 2% fat content for example, the natural moisture content may be approximately 80% be weight. A moisture increase within the scope of the invention for such a meat composition may comprise an increase which raises the moisture content over 80%. It will be noted that a higher moisture content in the moisture enhanced composition generally makes it easier to produce a relatively higher pH in the meat composition.

The concentration of ammonium hydroxide solution produced in the moisture enhanced comminuted meat composition will depend upon the nature of the final product, since the pH level of a meat affects the taste of the cooked product. Where the final comminuted product is substantially unseasoned meat, it will generally be desirable to ensure that the pH of the uncooked meat composition is maintained below about 7.0. This is compared to a pH of about 5.5 to 5.7 for regular ground beef. However, where the final product is highly seasoned, the pH of the material may be raised to as much as 9.5 without damaging with the taste of the desired product. In every case, the amount of ammonium hydroxide solution produced in the moisture enhanced meat composition should be just enough to raise the pH of the resulting composition to the desired level. It is also desirable that the pH be consistent throughout the resulting meat composition. The mechanical action helps produce this relatively consistent pH level throughout the material.

The time required to produce the desired pH level in the moisture enhanced meat composition will depend upon how the solution is produced, the moisture content in the composition, and the temperature of the meat composition. Where the ammonium hydroxide solution is produced by allowing ammonia gas to go into solution in water in the moisture enhanced meat composition, relatively long periods of ammonia gas contact and mechanical action may be required to produce the desired pH increase. Of course, higher concentrations of ammonia gas will result in relatively faster ammonium hydroxide production as compared to lower concentrations of ammonia gas. In any event, the process of allowing ammonia gas to go into solution slowly from ammonia gas as mechanical action is applied to the comminuted meat is most suitable for finely comminuted meat batters. These batters include those made up of meat pieces having a maximum dimension of approximately one-eighth (0.125) inch or less. Alternatively, where the moisture increase and ammonium hydroxide solution in the comminuted meat is produced by adding ammonium hydroxide solution to the comminuted meat, or by adding gaseous or liquid ammonia and then water, the pH increase may be very rapid and the time required by the process is dictated by the time required to ensure that the material is thoroughly mixed to provide a consistent pH change throughout the material.

Since the pH enhancement process according to the invention is particularly applicable to meat batters used to produce hotdogs, sausage, or restructured meat products, forms of the invention include product forming operations along with the pH enhancement steps. The step of forming the meat batter into a desired shape and setting the material in that shape is shown at process block 18 in FIG. 1.

Many processes for forming a meat batter into a desired shape and then setting the batter in that shape are known in the art. Generally, the forming and setting steps may comprise any forming and setting steps which may be applied to meat batters. For certain types of restructured meat products for example, the step of forming the product into a desired shape may include containing the batter in a flexible container or bag and then placing the bag in a mold having the desired shape. The halves of the mold are then pressed together under high pressure to press the meat batter-filled bag into the desired shape as dictated by the shape of the mold. In some cases the pressure applied to the meat batter in the mold sets the batter in the desired shape. Also, the meat batter may be frozen or cooked in the mold to set the material in the desired shape. Alternatively, cooking or deep freezing may be performed on the formed meat composition after removal from the mold.

Other restructured meat products are formed during the cooking process. For example, a finely textured meat batter or emulsion may be formed into small pieces of meat resembling cooked ground beef by applying mechanical action to the batter as the batter is heated in a vessel. The invention also encompasses this forming and setting method.

The forming and setting step within the scope of the present invention may be performed somewhat differently for meat products such as hotdogs or sausages. In the case of hotdogs or sausages, the meat batter may be injected into an edible casing and the casing forces the meat batter into the desired shape. The filled and sealed hotdog or sausage casings may then be cooked and then distributed in a cooked/refrigerated form. Some types of sausage may alternatively be refrigerated in the uncooked form and distributed uncooked.

FIG. 2 shows one preferred apparatus 19 for performing the method according to the present invention. The apparatus includes a vessel 20 for containing a mass of comminuted meat. The level of the comminuted meat is shown at “L” in FIG. 2 for purposes of example. The vessel includes an outlet opening 21 at the bottom and a closed top 22. The closed top includes a purge vent 23 and a meat product inlet port 24. The apparatus 19 also includes an ammonia gas inlet 25 and a separate purge gas inlet 26 located in the vessel top 22. Of course, those skilled in the art will readily appreciate that other access openings into vessel 20 may be helpful or necessary, but are omitted from the diagrammatic representation shown in FIG. 2.

Two paddle assemblies 30 are mounted within vessel 20, each including a number of paddles 31. Each paddle assembly is driven about an axis extending generally perpendicular to the plane of the drawing sheet by a driving motor and transmission arrangement which is not shown in the figure. The two paddle assemblies 30 may be driven in counter rotating fashion with the assembly on the left driven clockwise or counter clockwise and the assembly on the right in FIG. 2 driven in the opposite direction.

The apparatus shown in FIG. 2 also includes an output pump or auger 34 connected to the outlet opening 21 at the bottom of vessel 20. Outlet pump 34 directs material from vessel 20 through a conduit 35 to a forming/setting system 36. As discussed above, the forming/setting system may be any forming and setting arrangement suitable for the particular product being produced. For hotdogs or sausages for example, the forming/setting system 36 may include a hotdog or sausage casing filling device and then a heating arrangement for cooking the raw hotdogs or sausages. Alternatively, forming/setting system 36 may include a system for filling flexible bags with meat batter and then placing the filled bags in a forming press to be pressed into a desired shape. This alternative may further include a cooking arrangement for cooking the formed product prior to freezing or refrigeration.

The apparatus shown in FIG. 2 may receive a mass of comminuted meat through inlet port 24. The received material may already have water added or water may be added once the material is in vessel 20. In either case, ammonium hydroxide solution may be produced in the moisture enhanced meat composition in vessel 20 by creating an ammonia atmosphere in the area above the meat level L, and by applying mechanical action to the moisture enhanced meat composition through paddle assemblies 30. The paddle assemblies 30 circulate the meat composition in the vessel and continuously expose new material to the ammonia gas at the top of the vessel. This contact between the ammonia gas and moisture enhanced meat composition allows ammonia to go into solution in the water contained in the batter to form the desired ammonia hydroxide solution. Once sufficient ammonium hydroxide has gone into solution to produce the desired pH in the meat composition, the meat composition may then be pumped to the forming/setting system 36 for forming into the desired products.

It will be appreciated that the pH enhanced meat composition produced according to the invention may be mixed with other material to form a final meat batter. This is particularly the case with some batters for producing restructured meat products. The process according to the invention may be applied to an initial meat composition comprising a finely comminuted meat, and then the resulting pH enhanced finely comminuted meat or meat paste may be combined with relatively large chunks of meat to produce the desired batter. In this case, the large pieces of meat may be added to the final pH enhanced composition in vessel 20, or may be added to the pH enhanced composition after it is removed from vessel 20.

The apparatus 19 in FIG. 2 may also be used for first applying ammonia to an initial comminuted meat in vessel 20 and then adding water to the ammoniated meat. In this case, the ammonium hydroxide solution in the meat composition is produced as free ammonia on the ammoniated meat goes into solution in the added water. Paddle assemblies 30 may be operated to ensure that the ammonium hydroxide solution is well distributed through the meat composition.

FIG. 3 shows an alternate apparatus 40 for performing the method according to the invention. The apparatus in FIG. 3 includes a vessel 41 having a top vent 42 and a bottom outlet opening 43. Vessel 41 also includes one or more feed ports 44 for feeding an initial comminuted meat or moisture enhanced meat composition into the vessel. The level the meat composition in vessel 41 is shown at “M” in FIG. 3. Similar to FIG. 2, the bottom outlet opening 43 is connected to a pump or auger 46 which is in turn connected to a conduit 47 for directing the meat composition to a forming/setting system 48.

Unlike the apparatus shown in FIG. 2, mechanical action is applied in the apparatus of FIG. 3 by injecting a suitable gas into the meat composition. The gas may be air, nitrogen, oxygen, or any other suitable gas or mixture of gases. Regardless of the type of gas used, the mixing gas is injected preferably through a manifold 50 at the bottom of vessel 41 and allowed to bubble up through the meat composition. Eventually the injected gas exits vessel 41 through top vent 42. The injection pressure must be a pressure higher than the hydrostatic pressure exerted by the column of material in the vessel in order to allow the gas to flow into vessel 41. In this form of the invention the movement of the gas bubbles through the meat composition produces the desired mechanical action in the comminuted meat composition.

In the form of the invention shown in FIG. 3, the desired ammonium hydroxide solution may be produced in the meat composition by injecting ammonia gas into the bottom of vessel 41 through ammonia manifold 51. Although this separate manifold 51 is shown for the ammonia gas, it will be appreciated that the ammonia may be included in the gas used to produce the mechanical action in the comminuted material. Alternatively, the ammonium hydroxide solution in the comminuted meat may be produced by adding aqueous ammonia to the comminuted material in the vessel through a suitable conduit into the vessel. As with the apparatus shown in FIG. 2, water may be added to the meat material in the vessel 41 through a suitable conduit, or may be added prior to reaching the vessel.

The above described preferred embodiments are intended to illustrate the principles of the invention, but not to limit the scope of the invention. Various other embodiments and modifications to these preferred embodiments may be made by those skilled in the art without departing from the scope of the following claims.

1. A method for producing a pH enhanced comminuted meat composition, the method including the steps of:
(a) increasing the moisture content of a comminuted meat composition to produce a moisture enhanced meat composition, the comminuted meat made up at least partially of small comminuted meat pieces; and
(b) producing an ammonium hydroxide solution in the comminuted meat composition.

2. The method of claim 1 further including the step of applying mechanical action to the moisture enhanced meat composition after producing the ammonium hydroxide solution in the comminuted meat composition.

3. The method of claim 2 wherein the steps of increasing the moisture content in the comminuted meat and producing the ammonium hydroxide solution in the comminuted meat composition comprises the step of adding a solution of ammonium hydroxide to the comminuted meat composition.

4. The method of claim 1 wherein the step of increasing the moisture content of the comminuted meat composition includes adding water to the comminuted meat composition.

5. The method of claim 4 wherein the step of producing the ammonium hydroxide solution in the comminuted meat composition includes contacting a surface of the moisture enhanced meat composition with ammonia gas.

6. The method of claim 5 further including step of applying a mechanical action to the moisture enhanced meat composition after producing the ammonia hydroxide solution in the meat composition.

7. The method of claim 1 wherein the moisture enhanced meat composition includes seasonings and wherein the step of producing the ammonia hydroxide solution in the comminuted meat composition increases the pH of the moisture enhanced meat composition to a pH above approximately 7.0.

8. The method of claim 1 wherein moisture enhanced meat composition does not include seasonings and the step of producing the ammonium hydroxide solution in the comminuted meat composition raises the pH of the moisture enhanced meat composition to the pH no greater than approximately 7.0.

9. The method of claim 2 further including the steps of:
(a) placing the moisture enhanced meat composition into a desired shape after producing the ammonium hydroxide solution in the comminuted meat composition and after applying mechanical energy to the meat composition; and
(b) setting the meat product in that desired shape.

10. The method of claim 9 wherein the step of placing the moisture enhanced meat composition into a desired form includes containing the meat composition in a flexible container and placing the flexible container in a mold to force the meat composition into the desired shape.

11. The method of claim 10 wherein the step of setting the moisture enhanced meat composition in the desired shape comprises heating the moisture enhanced meat composition to at least partially cook the composition.

12. A method of producing a pH enhanced comminuted meat composition, the method including the steps of:
(a) adding water to a mass of comminuted meat to produce a moisture enhanced meat composition, the comminuted meat being made up at least partially of small comminuted meat pieces;
(b) placing ammonia gas in contact with the moisture enhanced meat composition; and
(c) applying mechanical action to the meat composition after placing ammonia gas in contact with the meat composition.

13. A method of producing a pH enhanced comminuted meat composition, the method including the steps of:
(a) adding ammonia hydroxide solution to a mass of comminuted meat, the comminuted meat being made up at least partially of small comminuted meat pieces; and
(b) applying mechanical action to the comminuted meat after adding the ammonium hydroxide solution.

14. A meat product produced by:
(a) increasing the moisture content of a mass of comminuted meat composition to produce a moisture enhanced meat composition, the comminuted meat being made up at least partially of small comminuted meat pieces;
(b) producing an ammonium hydroxide solution in the comminuted meat composition;
(c) applying mechanical action to the moisture enhanced meat composition after producing the ammonium hydroxide solution in the comminuted meat composition; and
(d) setting the moisture enhanced meat composition in a desired form.

15. The method of claim 14 wherein the steps of increasing the moisture content in the comminuted meat and producing the ammonium hydroxide solution in the comminuted meat composition comprises the step of adding a solution of ammonium hydroxide to the comminuted meat composition.

16. The method of claim 14 wherein the step of increasing the moisture content of the comminuted meat composition includes adding water to the comminuted meat composition.

17. The method of claim 16 wherein the step of producing the ammonium hydroxide solution in the comminuted meat composition includes contacting a surface of the moisture enhanced meat composition with ammonia gas.

18. The method of claim 17 further including step of applying mechanical action to the moisture enhanced meat composition after producing the ammonia hydroxide solution in the comminuted meat composition.

19. The method of claim 14 wherein the moisture enhanced meat composition includes seasonings and wherein the step of producing the ammonia hydroxide solution in the comminuted meat composition increases the pH of the moisture enhanced meat composition to a pH above approximately 7.0.

20. The method of claim 14 wherein moisture enhanced meat composition does not include seasonings and the step of producing the ammonium hydroxide solution in the comminuted meat composition raises the pH of the moisture enhanced meat composition to the pH no greater than approximately 7.0.

21. A method for producing a pH enhanced comminuted meat composition, the method including the steps of:
(a) increasing the moisture content of a comminuted meat composition to produce a moisture enhanced meat composition, the comminuted meat composition being made up of small comminuted meat pieces;
(b) producing an ammonium hydroxide solution in the comminuted meat composition;
(c) applying mechanical action to the moisture enhanced meat composition after producing the ammonium hydroxide solution in the comminuted meat composition; and
(d) combining the moisture enhanced meat composition with a meat composition including large comminuted meat pieces.

22. A method for producing a pH enhanced comminuted meat composition, the method including the steps of:
(a) adding ammonia to a comminuted meat to produce an ammoniated meat composition, the comminuted meat made up at least partially of small comminuted meat pieces; and
(b) adding water to the ammoniated meat composition.

23. The method of claim 22 further including the step of applying mechanical action to the ammoniated meat composition and added water.
